(19) United States
(12) Patent Application Publication
(10) Pub. No.: US 2008/0256871 A1
(43) Pub. Date: Oct. 23, 2008

(54) Step Actuator

(76) Inventor: Johann Bramauer, Ybbsitz (AT)

Correspondence Address: BARNES & THORNBURG LLP, 750-17TH STREET NW, SUITE 900, WASHINGTON, DC, 20006-4675, US

(21) Appl. No.: 11/884,803

(22) PCT Filed: Feb. 9, 2006
(86) PCT No.: PCT/EP2006/001132

§ 371 Date: Apr. 24, 2008

(30) Foreign Application Priority Data
Feb. 21, 2005 (AT) A 280/2005

(51) Int. Cl. E05F 15/00

(52) U.S. Cl. 49/339; 49/360

(57) ABSTRACT

A step drive for a movable step, the step drive being arranged below a swinging-sliding door. The step drive includes an opening-out mechanism located in a lower region of a secondary closing edge of the swinging-sliding door. The opening-out mechanism is connected to and actuated by a door drive and the opening-out mechanism interacts with the movable step.

The invention relates to a step drive for a movable step, such as a folding step or sliding step, arranged below a swinging-sliding door, wherein in the lower region of the secondary closing edge the swinging-sliding door has an opening-out mechanism which is connected to and can be actuated by the door drive.

Steps in rail vehicles are nowadays customarily driven by a dedicated motor or a pneumatic cylinder or rotary cylinder.

DE 42 18 006 discloses a drive device for foldable steps below a swinging-sliding door. The pivoting action of a pivoting roller lever comprising a journal engaging in a guide of the door leaf produces the swinging movement of the door leaf. The pivoting roller lever is coupled to the horizontal drive shaft of the step via a transmission shaft and a bevel gear mechanism. The pivoting roller lever is actuated via a dedicated drive element, for example in the form of a pneumatic cylinder. The pivoting roller lever is not connected to the door drive arranged in the upper region of the door. The use of two independent drives requires not only an elaborate synchronization of the two drive elements but also incurs considerable costs owing to the respective double design of the drive, levers, cylinders, etc.

DE 20 57365 discloses a folding drive whose horizontal pivot shaft is connected to and controlled by the vertical rotary shaft of a pivoting door, swinging door or pivoting-folding door. An opening-out mechanism for the door in the lower region is not provided.

In a few isolated instances, solutions are also known in which the step is driven via a linkage which operates with a door drive arranged in the roof region of the vehicle.

DE 27 23 995 discloses a folding step for a swinging-sliding door which is connected to and can be pivoted by the door drive via a complicated lever mechanism in the region above the door leaf. A floor-side locking mechanism or opening-out mechanism for the door leaf is not provided. Such a complex lever mechanism connected to the folding step via a rod and a further lever is prone to failure and consequently requires frequent maintenance.

The prior art door drives are thus either directly connected to the door drive arranged in the upper region of the coach body via complicated, failure-prone and cost-incurring mechanisms, or require a dedicated drive synchronized with the door drive. The present invention is aimed at overcoming these disadvantages and providing a step drive which folds down and in, or extends and retracts, reliably with the opening and closing of the door.

According to the invention, these aims are achieved by a step drive of the initially mentioned type, characterized in that the opening-out mechanism interacts with the step.

The step drive according to the invention makes it possible for the opening-out or locking mechanism in the lower region of the door leaf to be used to drive the step. No additional drives, transmission mechanisms or the like are required. The step is thus brought into the folded-out state, or extended state in the case of sliding steps, at the same time as the door opens, and folds up, or retracts, as the door closes.

A folding step is preferably actuated by means of a rod which is pivotally mounted on a lever of the opening-out mechanism and on the step.

In the case of sliding steps, the movement is transmitted either directly, for example via an extension of a lever of the opening-out mechanism, or via connecting elements such as, for example, a lever system.

The invention will be explained in more detail below with reference to the drawing, in which:

FIG. 1 shows a step drive according to the invention with the door closed and the folding step locked,

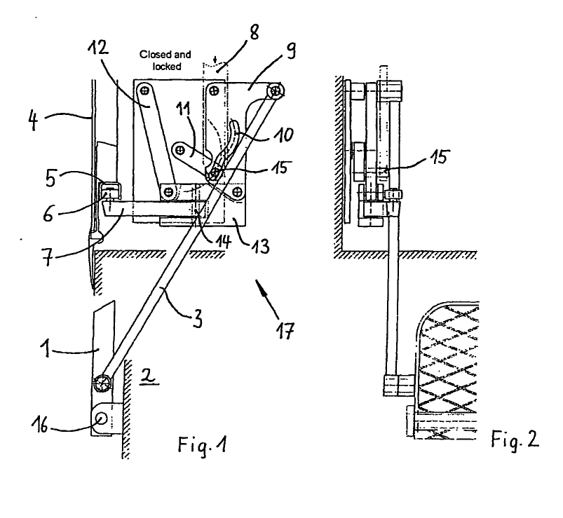

FIG. 2 shows a side view of the step drive shown in FIG. 1,

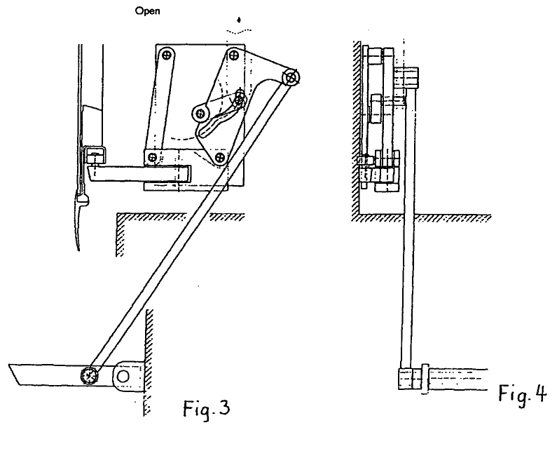

FIG. 3 shows a step drive according to the invention with the door open and the folding step folded out,

FIG. 4 shows a side view of the step drive shown in FIG. 3,

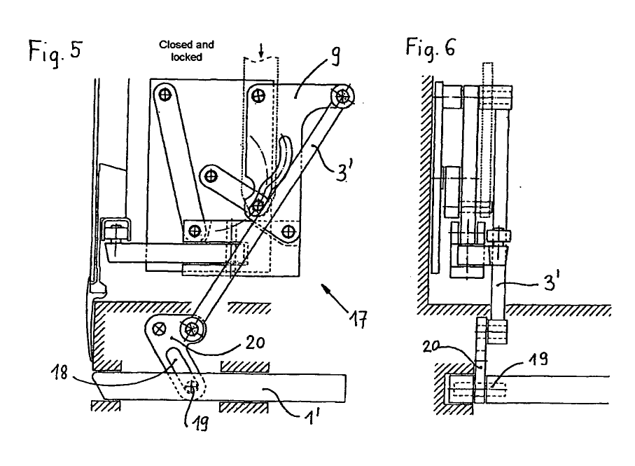

FIG. 5 shows a step drive according to the invention with the door closed and the sliding step retracted,

FIG. 6 shows a side view of the step drive shown in FIG. 5,

FIG. 7 shows a step drive according to the invention with the door open and the sliding step extended,

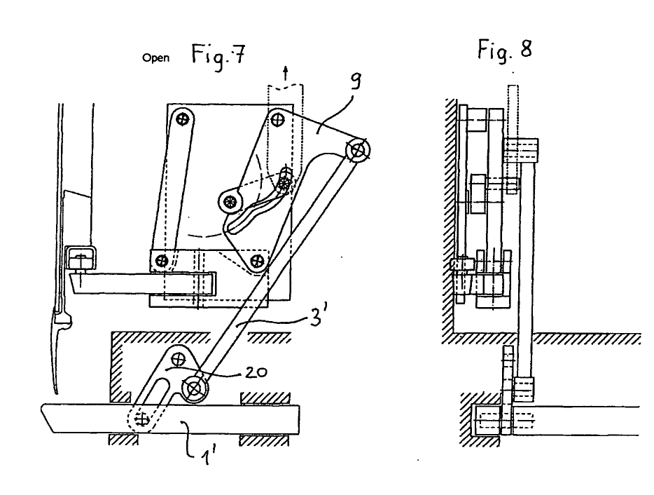

FIG. 8 shows a side view of the step drive shown in FIG. 7,

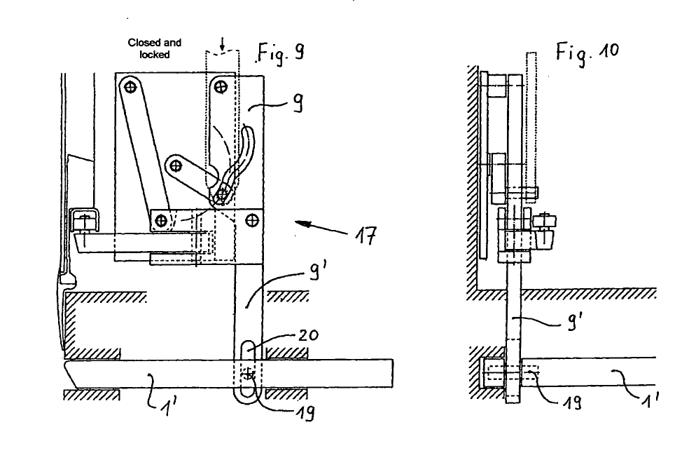

FIG. 9 shows a step drive according to the invention with the door closed and the sliding step retracted,

FIG. 10 shows a side view of the step drive shown in FIG. 9,

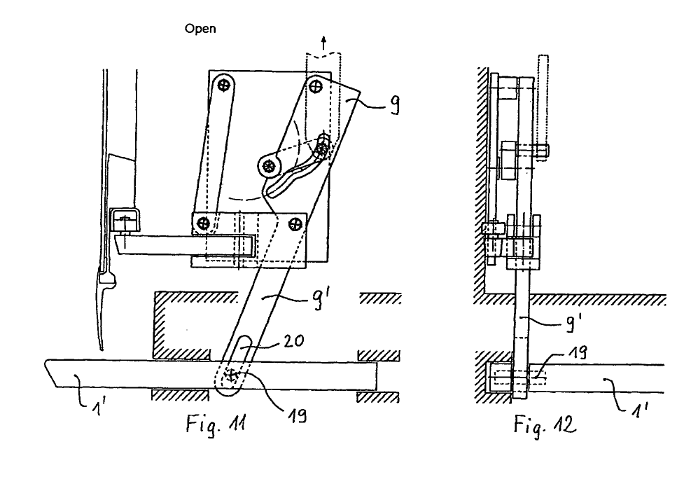

FIG. 11 shows a step drive according to the invention with the door open and the sliding step extended, and

FIG. 12 shows a side view of the step drive shown in FIG. 11.

FIG. 1 shows a step drive according to the invention in which a foldable step 1 is arranged on the coach body 2 below the entrance, such that it can pivot about a horizontal axis 16 which is substantially parallel to the imaginary door center plane. The opening-out mechanism 17 for the door leaf 4 in the lower region of the secondary closing edge ensures that the door leaf is swung away from the coach body 2. The opening-out mechanism 17 is actuated via a drive rod 8 which is connected to the door drive, which is situated in the upper region or above the door in the coach body. When the door opens, the rod 8 is pulled upward by the door drive, this causing the pivoting roller lever 7 and, with this, the door leaf 4 to be moved away from the coach body 2 via a lever mechanism. The engagement of a guide roller 6, which is rotatably mounted on the pivoting roller lever 7, in a guide rail 5 arranged at the lower end of the door leaf 4 allows the door leaf 4 to slide in the opening or closing direction.

The pivoting roller lever 7 is mounted in a mount 13 such that it can rotate about a vertical axis 14. The mount 13 is suspended from the coach body 2 on a rod 12 and a lever 9. The rod 12 and the lever 9 are each pivotally connected to the coach body 2, or a platform mounted on the coach body, on the one hand and to the mount 13 on the other hand. The four hinge points here form the corners of a parallelogram. A pin 15 which is situated at the end of the drive rod 8 and which is preferably rotatably mounted engages in a guide 10 of the lever 9. At the same time, the drive rod 8 is connected to a rod 11, which is rotatably mounted on the coach body or on the platform, so as to define a circular path for the pin 15 when the drive rod 8 is pulled upwardly. FIGS. 2 and 4 make it clear that, in the embodiment represented, the pin 15 passing through the guide 10 of the lever 9 connects the drive rod 8 and the rod 11 to one another.

According to the invention, the step 1 and the lever 9 are thus connected to one another by a connecting element 3. This element is pivotally connected both to the lever 9 and to the step 1. When the swinging-sliding door opens, the drive rod 8 moves upwardly and with its pin 15 forces the lever 9 to pivot toward the right. This movement presses the connecting element 3 in the direction of the step 1 and thereby causes the step to fold down.

In a preferred configuration, the guide 10 in the lever 9 is bounded by stops, and thus ensures not only that the folding step is securely held and locked while the vehicle is traveling but also that the step is securely held in the open position. In order to relieve the load on the step drive when the step is folded down, it is of course possible for additional stops (not shown) to be provided on the coach body itself. The two-part form of the guide 10 in combination with the rod 11 - the lower part of the guide extends along a circle at whose center point the rod 11 with the pin 15 is rotatably mounted—results in a dead-center line or a dead-center region which reliably prevents the possibility of the step being brought into a stepping position by the action of external forces when the door is closed.

The connecting element in the simplest case is a rod 3 which is pivotally connected both to the lever 9 and to the lateral edge of the step 1. In a preferred embodiment, the connecting element additionally comprises spring means which damp loads and vibrations and thus protect the opening-out mechanism 17 from damage. For example, two tubes capable of telescoping one inside the other can be connected to one another via a spring. However, it is also possible for the lever 9 and the step 1 to be connected via respective springs to the connection rod 3. In a particularly preferred embodiment, the length of the connecting element 3 is adjustable, for example via screws which allow two parts of the connecting element to be displaced relative to one another. This can be achieved, for example, via left-hand threads, right-hand threads or differential threads. It would also be conceivable for the connecting element to consist of a plurality of interacting levers. However, the outlay involved would make this a less preferred embodiment.

A torsion spring is preferably mounted in the axis of rotation of the step. It serves to secure the position of the folded-in stepboard while the vehicle is traveling.

A particular advantage of the invention lies in the flat design (FIGS. 2 and 4) of the step drive together with the opening-out mechanism for the door leaf. The whole assembly can thus be mounted compactly on a vertical wall of the doorway and be provided with a covering without taking up much space as a result. To make access impossible for unauthorized persons, the assembly consisting of the opening-out mechanism and step drive can of course also be arranged behind the vertical wall of the doorway.

The compact design and the fact that all the axes of rotation extend horizontally mean that ground clearance is also ensured. Since only drilled holes are required in one direction, it is also possible for the production outlay on a step drive according to the invention to be kept extremely low.

The invention is not restricted to the exemplary embodiment represented. Of course, a step which can be folded upward would also be conceivable. In that case the connecting element could act at a point beyond the hinge 16 on an extension of the step 1, such that a downward pressing movement of the connecting element causes an upward folding of the step.

The embodiments of FIGS. 5 to 8 show that the idea according to the invention is applicable not only to folding steps but also to sliding steps 1′. The sliding step 1′ is arranged below the entrance such that it can slide substantially horizontally in a guide. The opening-out mechanism 17 for the door is the same as in the preceding exemplary embodiment. The opening-out mechanism 17 now interacts with the sliding step 1′ via a rod 3′, and an additional lever 20 which is mounted below the entrance about a horizontal axis parallel to the door leaf plane. For this purpose, the lever 20 has an opening 18 into which a pin 19 of the sliding step projects. The rod 3′ is pivotally mounted both on the lever 9 and on the lever 20. When the lever 20 pivots, it takes along the pin 19, causing the sliding step 1′ to extend. When the door closes, the lever 20 is pivoted in the other direction and pushes the sliding step into the locked position. The advantage of this variant lies in the fact that the additional lever 20 enables the step drive to be dimensioned in an extremely space-saving manner.

FIGS. 9 to 12 show a variant of the invention in which the opening-out mechanism 17 acts directly on the sliding step 1′, that is to say without connecting elements. To this end, the lever 9 has an elongate continuation or extension 9′ directed toward, the sliding step. Provided at the lower end of the extension 9′ is an elongate opening 21 into which a pin 19 of the sliding step 1′ projects. When the lever 9 together with its extension 9′ pivots, the sliding step 1′ is thus extended. The advantage of this variant lies in the fact that no additional moving parts, such as additional connecting elements and levers, are provided.

The invention is not restricted to the embodiments represented, but can be modified at will using the know-how of a person skilled in the art. Thus, for example, the arrangement and number of levers and connecting elements between the opening-out mechanism and the step can be modified depending on the space available in the lower doorway region. In the lever system itself can be provided dead-center mechanisms which prevent the step from sliding or folding out while the vehicle is traveling and at the same time relieve the load on the locking system of the door drive.

In the examples shown, it is always the lever 9 of the opening-out mechanism 17 that is connected to the step 1, 1′. However, it is possible in principle for any part of the opening-out mechanism that moves concomitantly during the opening movement, be it a rotating or sliding part, to be used as a starting point for the transmission of the movement to the step.

The transmission occurs either directly or via corresponding lever systems and/or connecting elements.

Instead of using bars and levers as connecting elements between the opening-out mechanism and step, it is also possible to use cable pulls or Bowden cables (these include double cables and flexball cables; in flexball cables the use of a wire is replaced by a thin steel rail guided by balls, which means that compressive forces can be transmitted as well).

1. A step drive for a movable step, the step drive arranged below a swinging-sliding door, and the step drive comprising:
an opening-out mechanism located in a lower region of a secondary closing edge of the swinging-sliding door:
the opening-out mechanism being connected to and actuated by a door drive; and
the opening-out mechanism interacts with the movable step.

2. The step drive as claimed in claim 1, wherein the opening-out mechanism interacts with the movable step via at least one connecting element.

3. The step drive as claimed in claim 2, wherein the at least one connecting element is pivotally mounted to a lever of the opening-out mechanism and is pivotably mounted to the movable step.

4. The step drive as claimed in claim 1, wherein the opening-out mechanism includes a lever interacting with the movable step, the lever having an opening into which a pin of the step projects.

5. The step drive as claimed in claim 2, wherein a length of the at least one connecting element is adjustable.

6. The step drive as claimed in claim 2, wherein the ate least one connecting element comprises spring means for damping vibrations.

7. The step drive as claimed in claim 6, wherein the spring means are provided between the at least one connecting element and the lever.

8. The step drive as claimed in claim 3, wherein when the movable step is in a locked position, the lever is situated in a dead-center position.

9. The step drive as claimed in claim 1, wherein the movable step is a folding step.

10. The step drive as claimed in claim 1, wherein the movable step is a sliding step.

11. The step drive as claimed in claim 2, wherein the at least one connecting element is a rod.

12. The step drive as claimed in claim 2, wherein the at least one connecting element is a lever.

13. The step drive as claimed in claim 2, wherein the at least one connecting element is a Bowden cable.

14. The step drive as claimed in claim 6, wherein the spring means are provided between the at least one connecting element and the movable step.
